(19) United States
(12) Patent Application Publication
(10) Pub. No.: US 2006/0290958 A1
(43) Pub. Date: Dec. 28, 2006

(54) Method and apparatus for setting color profile corresponding to user's preferred color when driver of image forming apparatus installed on computer

(75) Inventors: Mi-jung Jang, Suwon-si (KR); Kyeong-man Kim, Suwon-si (KR); Sun-ju Park, Yongin-si (KR); Hyun-soo Oh, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/473,010

(22) Filed: Jun. 23, 2006

(30) Foreign Application Priority Data
Jun. 23, 2005 (KR) 10-2005-0054388

(51) Int. Cl. H04N 1/60

(52) U.S. Cl. 358/1.9; 358/1.13

(57) ABSTRACT

A method and apparatus for setting a color profile corresponding to a user's preferred color when a driver of an image forming apparatus is installed on a computer are provided. The method includes the steps of displaying a dialog box in which a user can input information regarding the user's preferred color when the driver of the image forming apparatus is installed on the computer, receiving the input information through the dialog box, and setting a color profile corresponding to the input information in the computer. Since a user interface in which a user can input his or her color preference is provided and thus the user's color preference can be obtained through the user interface, a color image can be reproduced according to the user's color preference.

### BACKGROUND OF THE INVENTION

This application claims the benefit under 35 U.S.C. § 119(a) of Korean Patent Application No. 10-2005-0054388, filed on Jun. 23, 2005, in the Korean Intellectual Property Office, the entire disclosure of which is hereby incorporated by reference.

1. Field of the Invention

The present invention relates to setting a color profile. More particularly, the present invention relates to a method and apparatus for setting a color profile when a driver of an image forming apparatus is installed on a computer.

2. Description of the Related Art

Conventional image forming apparatuses provide predetermined colors regardless of color preferences of users. Therefore, users have to either use colors provided by conventional image forming apparatuses regardless of their color preferences or use other image forming apparatuses that provide desired colors.

Accordingly, there is a need for a method and apparatus that provide desired colors in accordance with a user's color preferences.

### SUMMARY OF THE INVENTION

An aspect of the present invention is to address at least the above problems and/or disadvantages and to provide at least the advantages described below. Accordingly, an aspect of the present invention is to provide a method and apparatus for setting a color profile corresponding to a user's preferred color when a driver of an image forming apparatus is installed on a computer.

According to an aspect of the present invention, a method of setting a color profile corresponding to a user's preferred color when a driver of an image forming apparatus is installed on a computer is provided. The method includes the steps of displaying a dialog box in which a user can input information regarding the user's preferred color when the driver of the image forming apparatus is installed on the computer, receiving the input information through the dialog box, and setting a color profile corresponding to the input information in the computer.

According to another aspect of the present invention, an apparatus for setting a color profile corresponding to a user's preferred color when a driver of an image forming apparatus is installed on a computer is provided. The apparatus includes a user interface unit displaying a dialog box in which a user can input information regarding the user's preferred color when the driver of the image forming apparatus is installed on the computer and receiving the input information through the dialog box, and a profile setting unit setting a color profile corresponding to the input information in the computer.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a flowchart of a method of setting a color profile corresponding to a user's preferred color when a driver of an image forming apparatus is installed on a computer according to an exemplary embodiment of the present invention;

FIG. 2 illustrates a dialog box according to an exemplary embodiment of the present invention;

FIG. 3 illustrates a dialog box according to another exemplary embodiment of the present invention; and

FIG. 4 is a block diagram of an apparatus for setting a color profile corresponding to a user's preferred color when a driver of an image forming apparatus is installed on a computer according to an exemplary embodiment of the present invention.

Throughout the drawings, the same reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

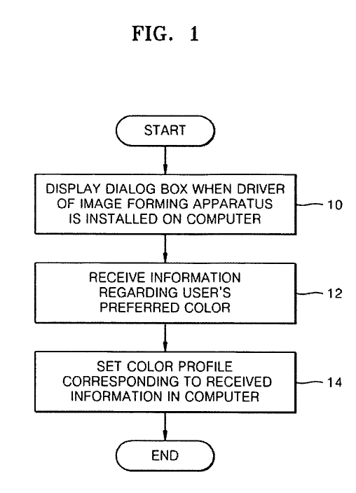

FIG. 1 is a flowchart of a method of setting a color profile corresponding to a user's preferred color when a driver of an image forming apparatus is installed on a computer according to an exemplary embodiment of the present invention. Referring to FIG. 1, when a driver of an image forming apparatus is installed on a computer, a dialog box in which a user can input information regarding a preferred color is displayed (operation 10). The driver of the image forming apparatus is a program which is installed on a computer to drive the image forming apparatus. The image forming apparatus is an apparatus, such as a printer, which prints images. The information regarding a preferred color denotes information regarding a color that a user desires to express, such as skin color, sky blue, or green.

In the present exemplary embodiment, the dialog box is displayed while the driver of the image forming apparatus is being installed on the computer to allow a user to input his or her color preference. Using the dialog box, the user inputs information regarding tone, brightness, and chroma of a preferred color.

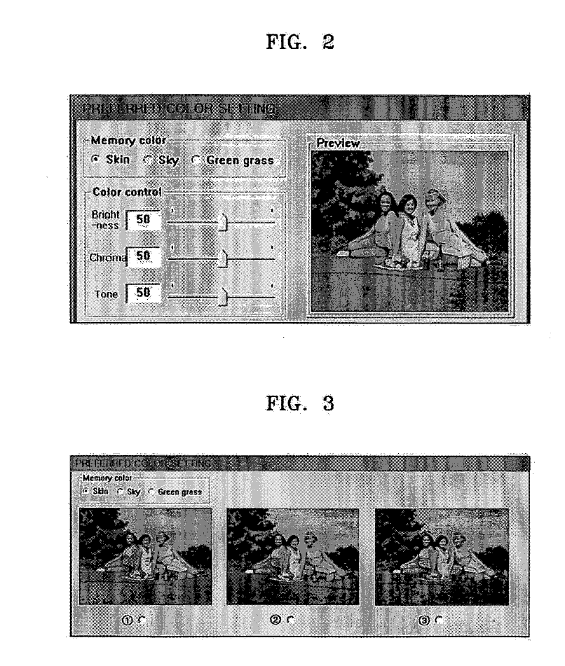

FIG. 2 illustrates a dialog box according to an exemplary embodiment of the present invention. Referring to FIG. 2, a user can set skin color, sky blue, or green as the user's preferred color using the dialog box. In particular, the user can also input information regarding tone, brightness, and chroma of a preferred color.

FIG. 3 illustrates a dialog box according to another exemplary embodiment of the present invention. Referring to FIG. 3, three identical images \textcircled{1}, \textcircled{2}, and \textcircled{3} with different color schemes are displayed. Thus, a user can select an image with a desired color scheme.

Referring back to FIG. 1, the user inputs information regarding a preferred color using the dialog box of FIG. 2 or 3 (operation 12). When the dialog box of FIG. 2 is displayed, the user inputs information regarding tone, brightness, and chroma of skin color, sky blue, or green. When the dialog box of FIG. 3 is displayed, a user inputs information regarding tone, brightness, and chroma of skin color, sky blue, or green by selecting one of the three identical images \textcircled{1}, \textcircled{2}, and \textcircled{3}.

Next, a color profile which corresponds to the information input by the user is set in the computer (operation 14). Specifically, when the user inputs information regarding a preferred color in operation 12, a color profile corresponding to the input information is generated and set in the computer. The color profile corresponding to the input information is generated using a color profile generating algorithm. The color profile thus generated is set in the computer for image formation.

Alternatively, the color profile corresponding to the input information may be detected from a plurality of color profiles and set in the computer. When there are a plurality of color profiles available for each preferred color, a color profile corresponding to information regarding a color selected by a user is detected from the color profiles. Then, the detected color profile is set in the computer for image formation.

An apparatus for setting a color profile according to information regarding a user's preferred color when a driver of an image forming apparatus is installed on a computer according to an exemplary embodiment of the present invention will now be described with reference to attached drawings.

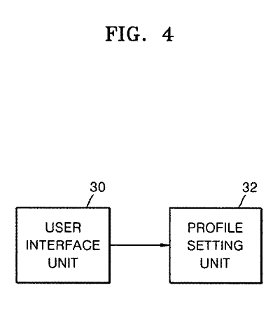

FIG. 4 is a block diagram of an apparatus for setting a color profile corresponding to a user's preferred color when a driver of an image forming apparatus is installed on a computer according to an exemplary embodiment of the present invention. Referring to FIG. 4, the apparatus includes a user interface unit 30 and a profile setting unit 32.

When a driver of an image forming apparatus is installed on a computer, the user interface unit 30 displays a dialog box in which a user can input information regarding a preferred color. The user interface unit 30 displays the dialog box while the driver of the image forming apparatus is being installed on the computer. Specifically, the user interface unit 30 displays the dialog box in which a user can input information regarding tone, brightness, and chroma of a preferred color.

The user interface unit 30 may display the dialog box of FIG. 2 such that a user can set skin color, sky blue, or green as a preferred color or may display the dialog box of FIG. 3 showing the three identical images \textcircled{1}, \textcircled{2}, and \textcircled{3} with different color schemes. The user interface unit 30 receives information regarding a user's preferred color through the dialog box of FIG. 2 or 3 and transmits the information to the profile setting unit 32.

In detail, the user interface unit 30 which displays the dialog box of FIG. 2 receives information regarding tone, brightness, and chroma of skin color, sky blue, or green from a user through the dialog box of FIG. 2. The user interface unit 30 which displays the dialog box of FIG. 3 receives color information of one of the three identical images \textcircled{1}, \textcircled{2}, and \textcircled{3} with different color schemes from a user through the dialog box of FIG. 3.

The profile setting unit 32 sets a color profile corresponding to input information regarding a user's preferred color in the computer. Specifically, the profile setting unit 32 generates a color profile corresponding to input information regarding a user's preferred color and sets the color profile in the computer. The profile setting unit 32 can generate a color profile corresponding to input information regarding a user's preferred color using a color profile generating algorithm. The profile setting unit 32 sets the generated color profile in the computer for image formation.

Alternatively, the profile setting unit 32 may detect a color profile corresponding to input information from a plurality of color profiles and set the detected color profile in the computer. When there are a plurality of color profiles available for each preferred color, a color profile corresponding to information regarding a color selected by a user is detected from the color profiles. Then, the detected color profile is set in the computer for image formation.

As described above, a method and apparatus for setting a color profile corresponding to a user's preferred color when a driver of an image forming apparatus is installed on a computer provides a user interface in which a user can input his or her color preference and thus obtains the user's color preference through the user interface. Therefore, a color image can be reproduced according to the user's color preference. Since the user's color preference can be obtained, not through an independent application, but while the driver is being installed on the computer, a user can avoid a situation where the user has to modify a color profile to reproduce a desired color image after the driver is installed.

The present invention can also be implemented as computer-readable code on a computer-readable recording medium. The computer-readable recording medium may be any data storage device that can store data which can be thereafter read by a computer system. Examples of computer-readable recording medium include read-only memory (ROM), random-access memory (RAM), CD-ROMs, magnetic tapes, floppy disks, optical data storage devices, and carrier waves (such as data transmission through the Internet).

The computer-readable code can also be distributed over network-coupled computer systems so that the computer-readable code is stored and executed in a distributed fashion. Also, functional programs, code, and code segments for accomplishing the present invention can be easily construed by programmers skilled in the art to which the present invention pertains.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method of setting a color profile corresponding to a user's preferred color when a driver of an image forming apparatus is installed on a computer, the method comprising the steps:
displaying a dialog box in which a user can input information regarding the user's preferred color when a driver of the image forming apparatus is installed on a computer;
receiving the input information through the dialog box; and
setting a color profile corresponding to the input information in the computer.

2. The method of claim 1, wherein the step of displaying of the dialog box comprises the step of displaying a dialog box in which the user can input information regarding tone, brightness, and chroma of the preferred color.

3. The method of claim 1, wherein the step of setting the color profile comprises the step of generating the color profile corresponding to the input information and setting the color profile in the computer.

4. The method of claim 1, wherein the step of setting the color profile comprises the step of detecting the color profile corresponding to the input information from a plurality of color profiles and setting the color profile in the computer.

5. A computer readable medium having instructions for causing a computer to execute a method comprising the steps of:
displaying a dialog box in which a user can input information regarding the user's preferred color when a driver of the image forming apparatus is installed on a computer;
receiving the input information through the dialog box; and
setting a color profile corresponding to the input information in the computer.

6. The computer readable medium of claim 5, wherein the step of displaying of the dialog box comprises the step of displaying a dialog box in which the user can input information regarding tone, brightness, and chroma of the preferred color.

7. The computer readable medium of claim 5, wherein the step of setting the color profile comprises the step of generating the color profile corresponding to the input information and setting the color profile in the computer.

8. The computer readable medium of claim 5, wherein the step of setting the color profile comprises the step of detecting the color profile corresponding to the input information from a plurality of color profiles and setting the color profile in the computer.

9. An apparatus for setting a color profile corresponding to a user's preferred color when a driver of an image forming apparatus is installed on a computer, the apparatus comprising:
a user interface unit for displaying a dialog box in which a user can input information regarding the user's preferred color when the driver of the image forming apparatus is installed on the computer and receiving the input information through the dialog box; and
a profile setting unit for setting a color profile corresponding to the input information in the computer.

10. The apparatus of claim 9, wherein the user interface unit displays a dialog box in which the user can input information regarding tone, brightness, and chroma of the preferred color.

11. The apparatus of claim 9, wherein the profile setting unit generates the color profile corresponding to the input information and sets the generated color profile in the computer.

12. The apparatus of claim 9, wherein the profile setting unit detects the color profile corresponding the input information from a plurality of color profiles and sets the detected color profile in the computer.
